(19) United States
(12) Patent Application Publication
(10) Pub. No.: US 2015/0064079 A1
(43) Pub. Date: Mar. 5, 2015

(54) CATALYST SUBSTRATE MODULE FOR EXHAUST AFTERTREATMENT SYSTEM

(71) Applicant: ELECTRO-MOTIVE DIESEL, Inc., La Grange, IL (US)

(72) Inventors: Ajay Patel, Joliet, IL (US); Mahesh Munirajappa, Willowbrook, IL (US)

(73) Assignee: ELECTRO-MOTIVE DIESEL, Inc., La Grange, IL (US)

(21) Appl. No.: 14/547,163

(22) Filed: Nov. 19, 2014

(51) Int. Cl. B01D 53/88

(52) U.S. Cl. CPC B01D 53/885
USPC 422/310

(57) ABSTRACT

A catalyst substrate module for an exhaust aftertreatment system is provided. The catalyst substrate module comprises an outer containment wall, an inner containment wall, a first bar, a second bar, a first substrate element, a second substrate element, and a center member. The outer containment wall and the inner containment wall are co-planar and aligned along a common centerline. The first bar and the second bar are coupled to an inner face of the outer containment wall. The first substrate element is enclosed within an inner face of the inner containment wall and the second substrate element is captured within a space defined by the inner containment wall and the outer containment wall. Further, the center member extends along the centerline of the inner containment.

### TECHNICAL FIELD

The present disclosure relates to exhaust aftertreatment systems. More particularly, the present disclosure relates to a catalyst substrate for a catalytic converter and can be applied to filters of an exhaust aftertreatment system.

### BACKGROUND

Exhaust gases from internal combustion engines may contain substances, such as nitrogen oxides (NOx), hydrocarbons, carbon monoxide, particulate matter, and/or the like. Some exhaust gas substances may be unfavorable to the environment. Over the years, efforts have been made within the internal combustion engine industry to reduce unfavorable substances that may be present in exhaust gases before the gases are discharged into the atmosphere. This has been accomplished by improvement of the combustion process or/and by treatment of the exhaust gases and particulate matter. The exhaust gases can be treated by appropriate oxidation catalyst and/or by selective catalytic reduction (SCR) whereas particulate matter can be treated using oxidation catalyst and/or filter.

Exhaust treatment system may include a planar substrate that encompasses a significant portion of the internal flow conduit and as such the substrate is subject to significant pressure generated by the exhaust flow. In some cases, the substrate is subject to high vibration. The pressure or high vibration can slide the substrate from mantel or tear the substrate from mantel and slide the substrate out. United States Publication No. 2009/065296 illustrates a fixing device which includes a muffler and a catalyst mantle. The muffler has at least one clapboard on which the catalyst mantle is integrated. At least one block is configured to prevent the substrate from sliding to the exhaust terminal and a stopper is formed on the clapboard or an inner wall of the muffler to prevent the substrate sliding to the admission terminal The fixing device improves the fixing capacity of the substrate for arranging the catalyst mantle in the muffler. However, where multiple catalytic converters are included in a housing or module, especially in exhaust systems associated with large power systems, removal and replacement of an individual catalytic converter may be complicated.

### SUMMARY OF THE INVENTION

The present disclosure relates to a catalyst substrate module in an exhaust aftertreatment system.

In accordance with the present disclosure, the catalyst substrate module includes an outer containment wall, an inner containment wall, a first bar, a second bar, a first substrate element, a second substrate element, and a center member. The outer containment wall defines a first end, a second end, an inner face, and a centerline. The inner containment wall defines a first end, a second end, an inner face, an outer face and a centerline. The centerline of the inner containment wall is substantially aligned with the centerline of the outer containment wall. The first bar includes a first bar end, a second bar end, and a center bar portion. Each of the first bar end and second bar end of the first bar is connected to a portion of the inner face of the outer containment wall, wherein the center bar portion of the first bar substantially aligns with the centerline of the outer containment wall. The first ends of the inner containment wall and outer containment wall are structured and arranged to engage with the first bar. The second bar includes a first bar end, a second bar end, and a center bar portion. Each of the first bar end and the second bar end of the second bar is connected to a portion of the inner face of the outer containment wall, wherein the center bar portion of the second bar substantially aligns with the center line of the outer containment wall. The second ends of the inner containment wall and outer containment wall are structured and arranged to engage with the second bar. The first substrate element is enclosed within the inner face of the inner containment wall, and the first bar and second bar on each end of the inner containment wall. The second substrate element is positioned within a space defined by the outer face of the inner containment wall and the inner face of the outer containment wall. The second substrate element is enclosed by the first bar and the second bar, on each end of the inner containment wall and outer containment wall. Further, the center member extends along the centerline of the inner containment wall. The center member includes a first end and a second end. The first end of the center member is attached to the center bar portion of the first bar and the second end of the center member is attached to the center bar portion of the second bar.

### BRIEF DESCRIPTION OF THE DRAWINGS

FIG. 1 is a diagrammatic view of an engine with an exhaust aftertreatment system, in accordance with the concepts of the present disclosure;

FIG. 2 is a perspective view of a catalyst substrate module of the exhaust aftertreatment system of FIG. 1, with the substrate elements removed to illustrate the catalyst substrate module showing the containment walls and bars, in accordance with the concepts of the present disclosure;

FIG. 3 is a perspective view of the catalyst substrate module of FIG. 2, to illustrate the catalyst substrate module showing the containment walls and bars, in accordance with the concepts of the present disclosure;

FIG. 4 is a perspective view of the catalyst substrate module of FIG. 2, with substrate elements positioned in the catalyst substrate module, in accordance with the concepts of the present disclosure; and

FIG. 5 is a sectional view of the catalyst substrate module along section line 5-5 of FIG. 4, such that a center member and the substrate elements are visible, in accordance with the concepts of the present disclosure.

### DETAILED DESCRIPTION

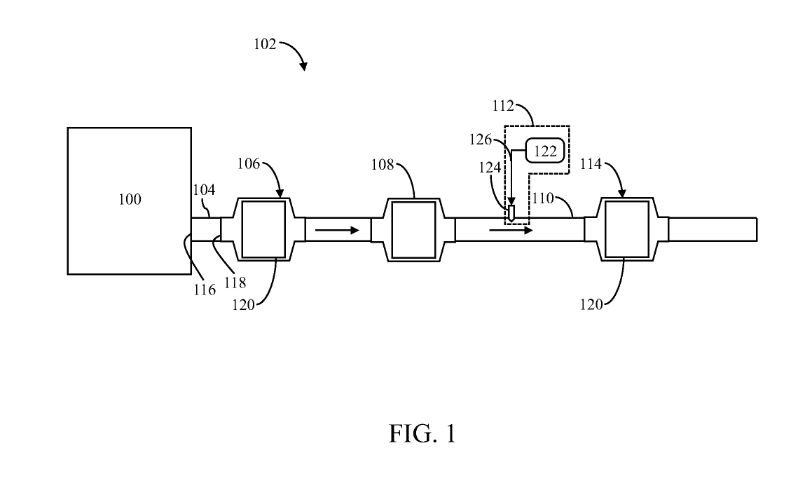

Referring to FIG. 1, there is shown an engine 100 with an exhaust aftertreatment system 102. The engine 100 may include features not shown, such as fuel systems, air systems, cooling systems, electrical systems, lubrication systems, and any other system each of which may be relevant to internal combustion engine technology and known to those having ordinary skill in the art. The engine 100 may be a type of combustion engine (internal combustion, turbine, gas, diesel, gaseous fuel, natural gas, propane, and/or the like), may be of any size, with a plurality of cylinders, and in multiple configurations (“V,” in-line, radial, and/or the like). The engine 100 may be used to power a machine or other device, which includes: locomotive applications, on-highway trucks or vehicles, off-highway trucks or machines, earth moving equipment, generators, aerospace applications, marine applications, pumps, stationary equipment, and/or other engine-powered applications known to those having ordinary skill in the art. The engine 100 may include a plurality of cylinders (not shown), where combustion of fuel and charge air occurs. The combustion in the cylinder of the engine 100 results in the formation of exhaust gases. The exhaust gases from the cylinder may be navigated toward the exhaust aftertreatment system 102.

The exhaust aftertreatment system 102 may include a first exhaust conduit 104, a diesel oxidation catalyst 106, a diesel particulate filter 108, a second exhaust conduit 110, a reductant supply system 112, and a catalytic converter 114. The first exhaust conduit 104 may define an exhaust flow path and may be disposed along a flow direction of the exhaust gases. The first exhaust conduit 104 includes a first inlet 116 and a first outlet 118. The first inlet 116 of the first exhaust conduit 104 may be in fluid communication with one of the plurality of cylinders, such that, the exhaust gases that exit the cylinders are directed into the first exhaust conduit 104. The first outlet 118 may be in fluid communication with the diesel oxidation catalyst 106, which in turn, is in fluid communication with the diesel particulate filter 108. The diesel particulate filter 108 may be positioned downstream of the diesel oxidation catalyst 106 or downstream of the catalytic converter 114. Each of the diesel oxidation catalyst 106 and the catalytic converter 114, houses a catalyst substrate module 120, such that the exhaust gases that flow through the second exhaust conduit 110 pass through the catalyst substrate module 120.

The diesel particulate filter 108 may be in fluid communication with the catalytic converter 114, via the second exhaust conduit 110. The second exhaust conduit 110 may be in fluid communication with the reductant supply system 112. The reductant supply system 112 includes a reductant source 122, which is fluidly connected to a reductant injector 124, via a supply line 126. The reductant source 122 may be a hydrocarbon source. The reductant injector 124 is provided for injection into the second exhaust conduit 110. Further, the second exhaust conduit 110 is positioned upstream of the catalytic converter 114 and is in fluid communication with the catalytic converter 114.

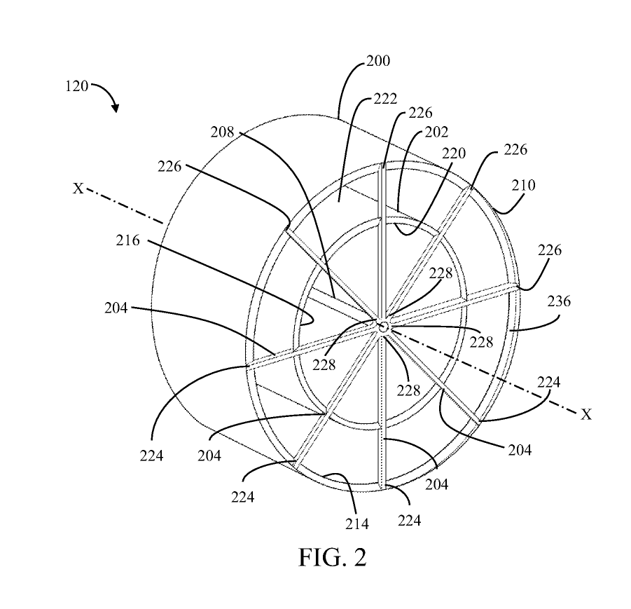

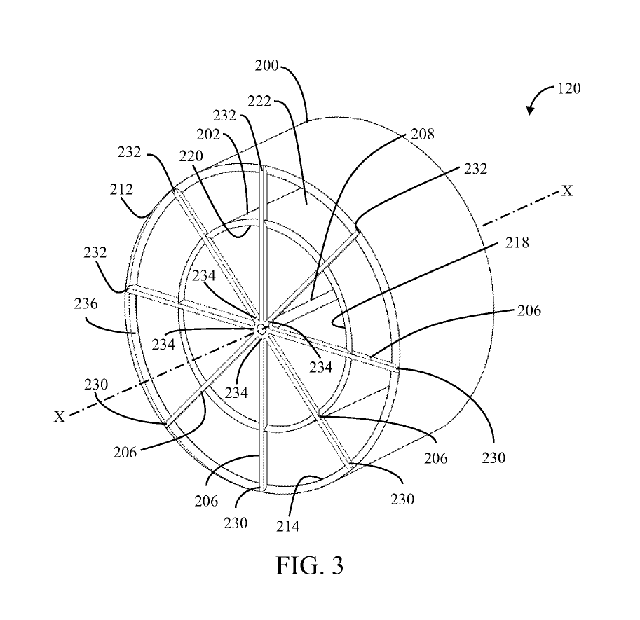

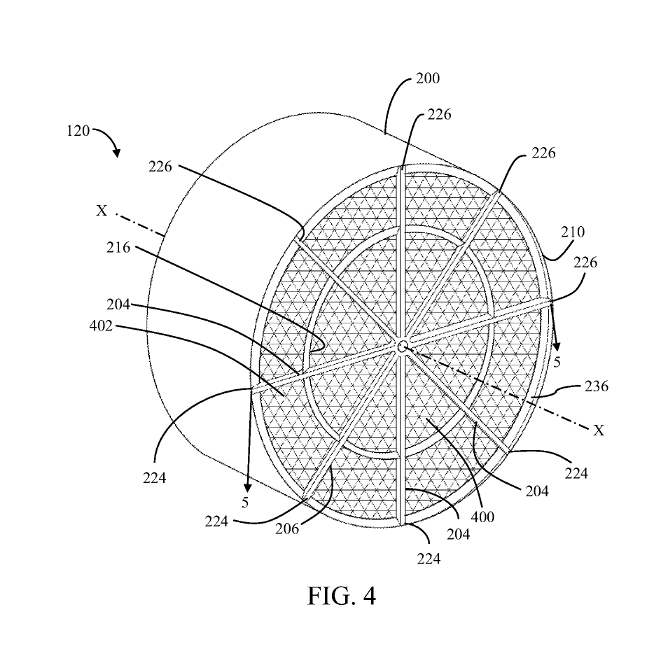

Referring to FIG. 2, there is shown a first side of the catalyst substrate module 120 and in FIG. 3, the opposite side or a second side of the catalyst substrate module 120 is illustrated. The catalyst substrate module 120 includes an outer containment wall 200, an inner containment wall 202, at least one first bar 204, at least one second bar 206, a first substrate element (shown as 400 in FIG. 4), a second substrate element (shown as 402 in FIG. 4), and a center member 208 extending along axial centerline X-X. The outer containment wall 200 includes a first end 210 and a second end 212. The first end 210 and the second end 212 includes the centerline X-X, which extends between the first end 210 and the second end 212 of the outer containment wall 200. The first end 210 and the second end 212 define an inner face 214. Similarly, the inner containment wall 202 includes a first end 216 and a second end 218. The first end 216 and the second end 218 includes a centerline X-X, which extends between the first end 216 and the second end 218 of the inner containment wall 202. The first end 216 and the second end 218 define an inner face 220 and an outer face 222. Further, the outer containment wall 200 and the inner containment wall 202 are concentrically coupled such that the first end 210 of the outer containment wall 200, and the first end 216 of the inner containment wall 202, is co-planar. Similarly, the second end 212 of the outer containment wall 200 and the second end 218 of the inner containment wall 202 may be substantially co-planar.

Further, the outer containment wall 200 and the inner containment wall 202 are reinforced together by the plurality of first bars 204 and the plurality of second bars 206. The plurality of first bars 204 and the plurality of second bars 206 span the diameter of the outer containment wall 200. The plurality of first bars 204 and the plurality of second bars 206 act as support members for the first substrate element (shown as 400 in FIG. 4) and the second substrate element (shown as 402 in FIG. 4). Each of the plurality of first bar 204 is attached on the first ends 210 and 216 of the outer containment wall 200 and the inner containment wall 202. The first bar 204 includes a first bar end 224, a second bar end 226, and a center bar portion 228. The first bar 204 is structured such that the first bar end 224 and the second bar end 226, are attached to the inner face 214, at the first end 210 of the outer containment wall 200. The center bar portion 228 of the first bar 204 is structured to align with the centerline X-X of the outer containment wall 200. Similarly, the second bar 206 is attached on the second sides of the outer containment wall 200 and the inner containment wall 202. The second bar 206 includes a first bar end 230, a second bar end 232, and a center bar portion 234. The second bar 206 is structured such that the first bar end 230 and the second bar end 232 are attached to the inner face 214, at the second end 212 of the outer containment wall 200. The center bar portion 234 of the first bar 204 is structured to align with the center line of the outer containment wall 200.

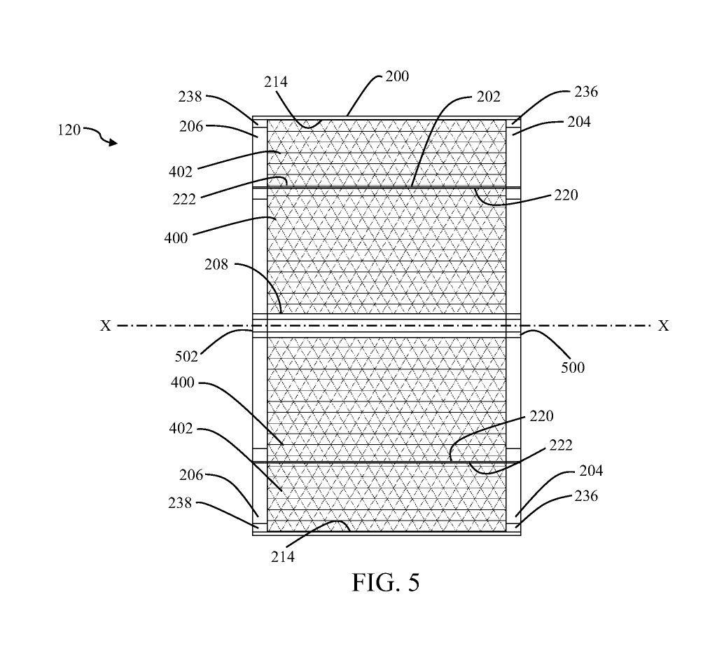

The center member 208 extends along the centerline X-X of the inner containment wall 202. The center member 208 with both ends is illustrated in FIG. 5.

In an embodiment, the catalyst substrate module 120 also includes a first ring 236 and a second ring 238. The first ring 236 is flushed at the inner face 214 of the first end 210 of the outer containment wall 200. Similarly, the second ring 238 is flushed at the inner face 214 of the second end 212 of the outer containment wall 200.

Referring to FIG. 4, there is shown the catalyst substrate module 120 depicted with a section line 5-5. The catalyst substrate module 120 is shown enclosing the first substrate element 400 and the second substrate element 402. The first substrate element 400 and the second substrate element 402 are equal in weight. The first substrate element 400 and the second substrate element 402 may include a metallic core and a porous ceramic coating on the metallic core. The first substrate element 400 and the second substrate element 402 may also include a washcoat, which substantially covers the ceramic coating and includes a catalyst material configured to react with the constituents within an exhaust flow of an exhaust-producing engine 100. Each of the first substrate element 400 and the second substrate element 402 may have any of a number variety of geometrical shapes. For example, the first substrate element 400 and the second substrate element 402 may have a cross-sectional shape, such as square, elliptical/oval/racetrack-shaped, rectangular, polygonal, or the like. The first substrate element 400 and the second substrate element 402 may also have a honeycomb configuration. The first substrate element 400 and the second substrate element 402 may define a plurality of elongated, hollow cells through which the exhaust gases may flow. The elongated cells may have a square cross-section, rectangular cross-section, hexagonal cross-section, or any suitable shape.

The first substrate element 400 has a circular cross-section and is structured to allow the exhaust gases to flow. The first substrate element 400 is enclosed within the inner face 220 of the inner containment wall 202, and extends along a length of the inner containment wall 202. In addition, the first substrate element 400 is enclosed by the first bar 204 and the second bar 206 and is between the first end 216 and the second end 218 of the inner containment wall 202.

The second substrate element 402 is structured to have a cross section of a concentric ring. The second substrate element 402 is positioned within the space defined by the outer face 222 of the inner containment wall 202 and the inner face 214 of the outer containment wall 200 and on each end of the inner containment wall 202 and outer containment wall 200 by the bars 204 the second bars 206.

Referring to FIG. 5, there is shown a sectional view of the catalyst substrate module 120. The cut section illustrates the outer containment wall 200, the inner containment wall 202, the first substrate element 400, the second substrate element 402, and the center member 208. The center member 208 includes a first end 500 and a second end 502. The first end 500 of the center member 208 is attached to the center bar portion 228 of the first bar 204. Similarly, the second end 502 of the center member 208 is attached to the center bar portion 234 of the second bar 206.

### INDUSTRIAL APPLICABILITY

In operation, an air/fuel mixture is combusted in the cylinders of the engine 100 and exhaust gases are produced. The exhaust gases are directed to the exhaust aftertreatment system 102 for treatment before release into the atmosphere. For this purpose, the exhaust gases are directed through the diesel oxidation catalyst 106 and the catalytic converter 114 for conversion of toxic pollutants to less toxic pollutants by catalysis of a redox or oxidation reaction. Both, the diesel oxidation catalyst 106 and the catalytic converter 114 are, equipped with the catalyst substrate module 120. The disclosed catalyst substrate module 120 includes the outer containment wall 200 and the inner containment wall 202, which house the first substrate element 400 and the second substrate element 402. The outer containment wall 200 and the inner containment wall 202 are reinforced with the first bar 204 and the second bar 206, on each end of the catalyst substrate module 120. Concentric structural arrangement of the first substrate element 400 and the second substrate element 402 contribute to the minimization of movement and weight of the first substrate element 400 and the second substrate element 402. Addition of the center member 208, along with the plurality of first bars 204 and the plurality of second bars 206, also contribute to the minimization of movement of the first substrate element 400 and the second substrate element 402. Further, the first ring 236 and the second ring 238, which reinforce the first bar 204 and the second bar 206 at the outer containment wall 200, provide a structural strength to the catalyst substrate module 120 and restrict axial movement of the catalyst substrate module 120 to prevent tearing. The proposed design is targeted at the reduction of strain by the minimization of the substrate element movement. The existing catalyst substrates face issues of mechanical failure due to breaking up of substrate element. Such failures result from shock loads and the vibratory engine environment exhaust pressure on face of the catalyst substrate. Hence, due to the robust structure, the proposed catalyst substrate module 120 eliminates the potential of the above-mentioned issues.

The many features and advantages of the disclosure are apparent from the detailed specification, and, thus, it is intended by the appended claims to cover all such features and advantages of the disclosure, which fall within the true spirit and scope thereof. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A catalyst substrate module for an exhaust aftertreatment system, the catalyst substrate module comprising:
an outer containment wall defining a first end, a second end, an inner face and a centerline;
an inner containment wall defining a first end, a second end, an inner face, an outer face and a center line, the center line of the inner containment wall being substantially aligned with the center line of the outer containment wall;
a first bar having a first bar end, a second bar end and a center bar portion, the first bar end and second bar end of the first bar each being connected to a portion of the inner face of the outer containment wall wherein the center bar portion of the first bar substantially aligns with the center line of the outer containment wall, the first ends of the inner containment wall and outer containment wall being structured and arranged to engage with the first bar;
a second bar having a first bar end, a second bar end and a center bar portion, the first bar end and the second bar end of the second bar each being connected to a portion of the inner face of the outer containment wall wherein the center bar portion of the second bar substantially aligns with the center line of the outer containment wall, the second ends of the inner containment wall and outer containment wall being structured and arranged to engage with the second bar;
a first substrate element being enclosed within the inner face of the inner containment wall, and the first bar and second bar on each end of the inner containment wall;
a second substrate element being captured within a space defined by the outer face of the inner containment wall and the inner face of the outer containment wall, and on each end of the inner containment wall and outer containment wall by first bar and second bar; and
a center member extending along the centerline of the inner containment wall and having a first end and a second end thereof, the first end of the center member being attached to the center bar portion of the first bar, the second end of the center member being attached to the center bar portion of the second bar.
